(19) United States
(12) Patent Application Publication
(10) Pub. No.: US 2001/0045919 A1
(43) Pub. Date: Nov. 29, 2001

(54) DISPLAY APPARATUS

(76) Inventors: TAKATOSHI ISHIKAWA, OSAKA (JP); KENJI ISHIBASHI, OSAKA (JP); YASUSHI KOBAYASHI, OSAKA (JP); AKIRU SATO, OSAKA (JP); YASUSHI TANIJIRI, OSAKA (JP); SOH OHZAWA, OSAKA (JP); HIDEKI NAGATA, OSAKA (JP)

Correspondence Address: BURNS DOANE SWECKER & MATHIS L L P, POST OFFICE BOX 1404, ALEXANDRIA, VA, 22313-1404, US

(21) Appl. No.: 09/145,222

(22) Filed: Sep. 1, 1998

(30) Foreign Application Priority Data
Sep. 4, 1997 (JP) H9-239266

(51) Int. Cl. G09G 5/00

(52) U.S. Cl. 345/8

(57) ABSTRACT

A display apparatus has a picture displaying portion and a temperature providing portion. The temperature providing portion generates heat. The picture displaying portion displays a picture based on a video signal generated by a picture information generating portion.

This application is based on application No. H9-239266 filed in Japan, the contents of which are hereby incorporated by reference.

### BACKGROUND OF THE INVENTION

1. Field of the Invention

The present invention relates to a display apparatus. The display apparatus includes a virtual reality apparatus such as a head mounted display (HMD), a relaxation system and a simulator for providing the viewer with a virtual reality space.

2. Description of the Prior Art

Conventional display apparatuses are designed to provide the viewer with a virtual reality space by use mainly of visual effects produced by providing pictures. For these apparatuses, means for enhancing psychological effects such as presence and reality have been groped for.

FIGS. 1 to 4 are brief block diagrams of conventional display apparatuses.

### First Conventional Example

In a display apparatus of FIG. 1, video signals generated in two-dimensional (2-D) video signal generating portion 100 are supplied to picture displaying portion (e.g. a cathode-ray tube (CRT)) 101 in which 2-D pictures are displayed. The viewer can experience a virtual reality space by viewing the pictures displayed on the picture displaying portion 101. Televisions are a typical example of the display apparatus of FIG. 1.

### Second Conventional Example

In a display apparatus of FIG. 2, video signals generated in three-dimensional (3-D) video signal generating portion 102 are supplied to picture displaying portion (e.g. an HMD) 103 in which 3-D pictures are displayed. When the picture displaying portion 103 is an HMD, the viewer can experience a virtual reality space by viewing the pictures displayed on the display of the HMD that the viewer wears on his or her head.

### Third Conventional Example

In a display apparatus of FIG. 3, virtual reality (VR) space generating portion 104 generates 3-D picture information, and inner force sense information for providing the viewer with a sense of action and reaction in accordance with the movement of the viewer's hand or arm. The generated 3-D picture information is supplied to the picture displaying portion 103 in which 3-D pictures are displayed. The inner force sense information is supplied to inner force sense providing portion 105. The inner force sense providing portion 105, for example, provides the viewer's hand or arm with a force based on the supplied inner force sense information.

### Fourth Conventional Example

In a display apparatus of FIG. 4, the position and direction of the viewer's head is detected by a head track sensor 106. The detection result is supplied to the VR space generating portion 104. In the VR space generating portion 104, picture information is generated by the 3-D picture generating portion 102.

Then, the detection result of the head track sensor 106 is added to the picture information outputted from the 3-D picture generating portion 102. The resultant video signal is supplied to the picture displaying portion 103. In this apparatus, the picture viewed by the viewer is successively changed to the picture in the direction of the viewer's line of sight. By viewing the pictures thus provided, the viewer can experience a virtual reality space.

In the above-described display apparatuses, picture information sometimes includes sound information. For example, a display apparatus is disclosed that is designed to enhance presence with stereo sound provided in accordance with the picture.

A special conventional example is a motorbike simulator in which a picture in accordance with the speed is provided and by sending wind from the front by use of a fan or a compressor and changing the pressure of the wind, psychological effects in the driver's (viewer's) virtual reality space experience are enhanced.

In display apparatuses using visual effects, since the picture brightness of current common display devices (liquid crystal displays (LCDs) and CRTs) is approximately 150 cd/m², glaring pictures including sunlight or flames and pictures that make the viewer feel hotness cannot be displayed, so that reality is deteriorated. Visually providing pictures with a wide range of brightness can be achieved by forming pictures directly on the retinas through two-dimensional scanning of a laser beam.

However, even if natural pictures (resolution, retinal image size, parallax information, brightness, contrast, etc.) can be displayed, light rays outside the visible region cannot be reproduced. In a real space, natural light includes infrared rays and ultraviolet rays that are outside the visible region. In a real space, one feels, for example, different senses of brightness such as intense sunlight and weak sunlight through the skin due to the action of infrared rays (in the case of intense sunlight, one even feels a pain according to the intensity), and in front of a fireplace, one feels heat radiation through the skin.

By reproducing with a display apparatus the action of infrared rays felt through the skin, presence is further enhanced. Reproduction of the action of infrared rays is, specifically, to provide the viewer with a sense of temperature. Provision of a sense of temperature not only reproduces the action of infrared rays but largely influences human psychology. For example, when a sense of terror or astonishment is provided or when a picture providing these senses is displayed, psychological effects are enhanced by providing coldness or hotness for a moment. However, for prior art display apparatuses, there is no technology of enhancing presence by providing a sense of temperature.

### SUMMARY OF THE INVENTION

An object of the present invention is to provide a display apparatus providing the viewer with a virtual reality space with higher presence and reality.

To achieve the above-mentioned object, a display apparatus according to the present invention comprises: picture displaying means for providing a viewer with a picture; and heat generating means for providing the viewer with heat.

According to this structure, a sense of temperature such as coldness and warmth can be provided to the viewer by the heat generating means. Since men always feel temperature in a real space, psychological effects produced by providing the viewer with a sense of temperature are great. For example, one feels hot in summer and cold in winter. One feels cold when having a shaved ice. In the above-described structure, since these senses can be provided to the viewer, a virtual reality space with higher presence can be provided.

A display apparatus according to the present invention comprises: means for outputting a video signal; means for displaying a picture based on the video signal; and means for generating heat based on the video signal.

According to this structure, pictures and temperature are provided as information on a virtual reality space. Consequently, for example, by providing a sense of temperature to the face in accordance with the picture, a space that produces complex psychological effects including both the sense of sight and the sense of temperature can be provided to the viewer, so that a virtual reality space with higher presence and reality can be provided. When a picture of the sun is displayed, a sense of temperature which makes the viewer to feel hot is provided to the face.

A display apparatus according to the present invention comprises: picture displaying means for providing a viewer with a picture; sound outputting means for providing the viewer with sound; and heat generating means for providing the viewer with heat.

According to this structure, sound, temperature and pictures are provided as information on a virtual reality space. When a sound producing a sense of terror or sad music is provided by the sound outputting means, a sense of coldness is provided to the viewer by the heat generating means and when Latin music or cheerful rock music is provided, a sense of warmth is provided, thereby enhancing psychological effects.

### BRIEF DESCRIPTION OF THE DRAWINGS

This and other objects and features of this invention will become clear from the following description, taken in conjunction with the preferred embodiments with reference to the accompanied drawings in which:

FIG. 1 is a block diagram showing a schematic structure of the display apparatus of the first conventional example;

FIG. 2 is a block diagram showing a schematic structure of the display apparatus of the second conventional example;

FIG. 3 is a block diagram showing a schematic structure of the display apparatus of the third conventional example;

FIG. 4 is a block diagram showing a schematic structure of the display apparatus of the fourth conventional example;

FIG. 5 is a schematic view showing a viewer experiencing a virtual reality space by a display apparatus of a first embodiment, and a basic structure of the apparatus;

FIG. 6 is an external view of an HMD of the first embodiment;

FIG. 7 shows a concrete structure of temperature providing means;

FIG. 8 shows an example of a picture displayed on the HMD;

FIG. 9 is a block diagram showing picture information generating portion and portions associated therewith;

FIG. 10 is a block diagram showing inner force sense information generating portion and portions associated therewith;

FIG. 11 is a block diagram showing sound information generating portion and portions associated therewith;

FIG. 12 is a block diagram showing a schematic structure of the display apparatus of the first embodiment;

FIG. 13 is a block diagram showing a schematic structure of a display apparatus of a second embodiment;

FIG. 14 is a block diagram showing a schematic structure of a display apparatus of a third embodiment;

FIG. 15 is a block diagram showing a schematic structure of a display apparatus of a fourth embodiment;

FIG. 16 shows a viewer wearing a display apparatus of a fifth embodiment; and

FIG. 17 shows the viewer wearing the display apparatus of the fifth embodiment viewed from above.

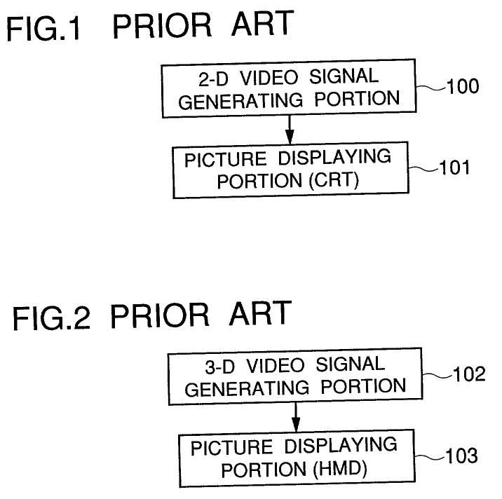

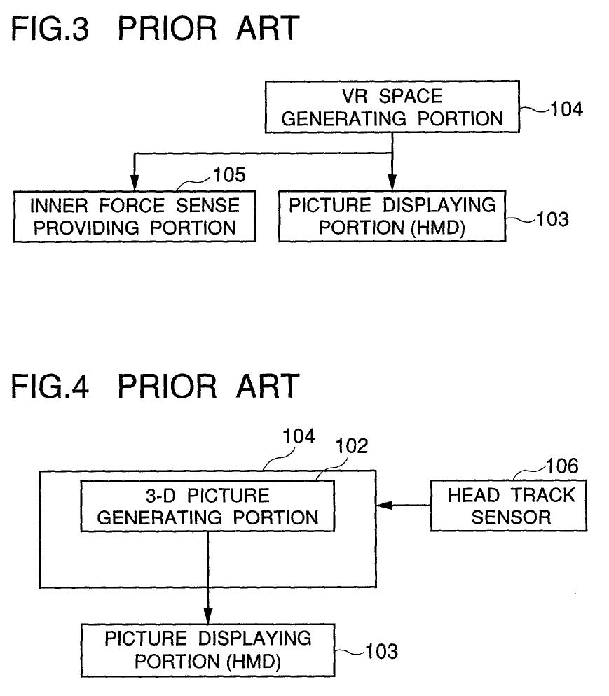

### DESCRIPTION OF THE PREFERRED EMBODIMENTS

First Embodiment

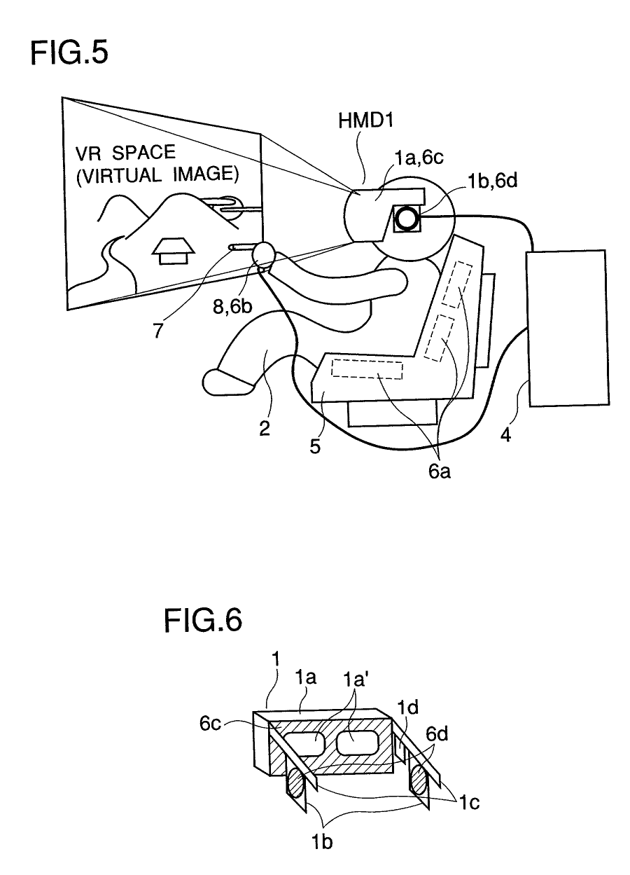

FIG. 5 shows a viewer 2 experiencing a virtual reality space by a display apparatus of this embodiment, and schematically shows a basic structure of this apparatus. Reference numeral 1 represents an HMD having picture displaying portion 1a and sound providing portion 1b. That is, the HMD 1 serves as picture and sound providing portion. The picture displaying portion 1a serves also as temperature providing portions 6c. The sound providing portion 1b comprises a headphone and serves also as temperature providing portions 6d. The HMD 1 also includes a head track sensor (not shown) for detecting the position of the head.

Reference numeral 7 represents inner force sense providing portion for providing fingers and hands of the viewer 2 with a reactional force when the viewer 2 grabs an object in the VR space with his or her hand. Reference numeral 8 represents an inner force sense sensor for detecting the movement of the hands of the viewer 2. The inner force sense sensor 8 serves also as temperature providing portion 6b for providing the hands of the viewer 2 with a sense of temperature.

The temperature providing portion 6b may be structured so as to be in contact with the back of a hand like in this embodiment, or may have any structure as long as it is in contact with a finger, an arm or a palm or that is disposed in the vicinity of a hand or an arm. The picture and sound providing portion 1, the inner force sense providing portion 7 and the temperature providing portions 6a, 6b, 6c and 6d constitute VR space providing means. Information provided by the VR space providing means allows the viewer 2 to experience a VR space.

Reference numeral 4 represents VR space generating portion for generating information provided by the VR space providing means. The VR space generating portion 4 comprises a workstation. The VR space generating means 4 is not limited to a workstation but may comprise two or more workstations or a personal computer. The configuration of the VR space generating portion 4 will be described later.

Reference numeral 5 represents a chair in which the viewer 2 sits when experiencing a virtual reality space with this apparatus. The chair 5 includes the temperature providing portions 6a through which the viewer 2 sitting in the chair 5 is provided with a sense of temperature. The temperature providing portions 6a , 6b, 6c and 6d comprise heating wire heaters or black-light lamps for providing warmth or hotness, and Peltier elements for providing coldness.

FIG. 6 is a more detailed external view of the HMD 1. The HMD 1 is designed so that when the viewer puts head holding members 1c on his or her ears, pupils (eyepieces) 1a′ of the picture displaying portion 1a are situated in positions substantially corresponding to the positions of the viewer's eyes, and that the headphone 1b serving as sound providing portion is situated in the vicinity of the viewer's ears. Reference numeral 1d is a head track sensor for detecting the position of the viewer's head. The temperature providing means 6c are provided on the surface of the picture displaying portion 1a that is opposed to the viewer's eyes. The temperature providing portions 6d are provided on the portions of the headphone 1b that come in contact with the ears.

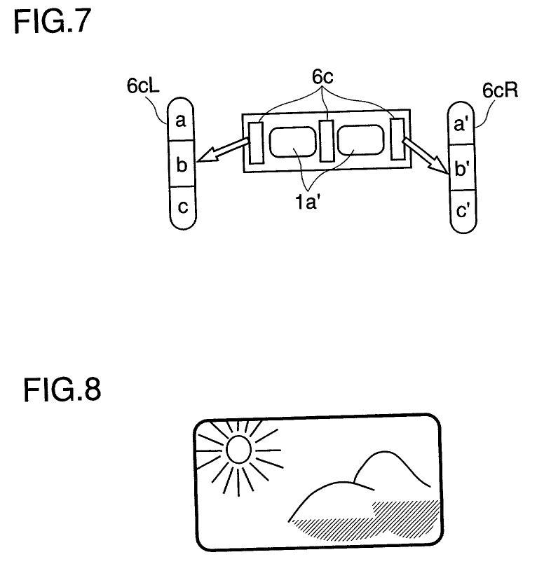

FIG. 7 shows a concrete structure of the temperature providing portions 6c. The temperature providing portions 6c are provided on the left and right sides of and between the eyepieces 1a′. Reference symbols 6cL and 6cR represent the enlarged views of the temperature providing portions on the left and right sides. The temperature providing portions 6cL and 6cR on the left and right sides are divided into three areas (“a”, “b”, “c” and “a”, “b”, “c”, respectively). Assume that the viewer views a picture as shown in FIG. 8. In this picture, the sun with high brightness is displayed in the upper left of the display screen and the shade of the mountains is displayed in the lower right. While the viewer receives sunlight with the entire face, the hotness received from the upper left is more intense.

To reproduce such a sense of temperature in a real space as precisely as possible, in the temperature providing portion 6cL of this embodiment, the highest temperature is provided in the area “a”, and the provided temperature decreases in the order of “b” and “c”. In the temperature providing portion 6cR, the lowest temperature is provided in the area “c”. This control is performed by the VR space generating portion 4. Hereinafter, a detailed configuration of the VR space generating means 4 will be described.

The VR space generating means 4 of this embodiment includes picture information generating portion, inner force sense information generating portion and sound information generating portion. The VR space generating portion 4 also includes processing portions and controlling portions associated with the above-mentioned three portions. The signal processing flow will be described with reference to block diagrams showing the generating portions and the portions associated therewith.

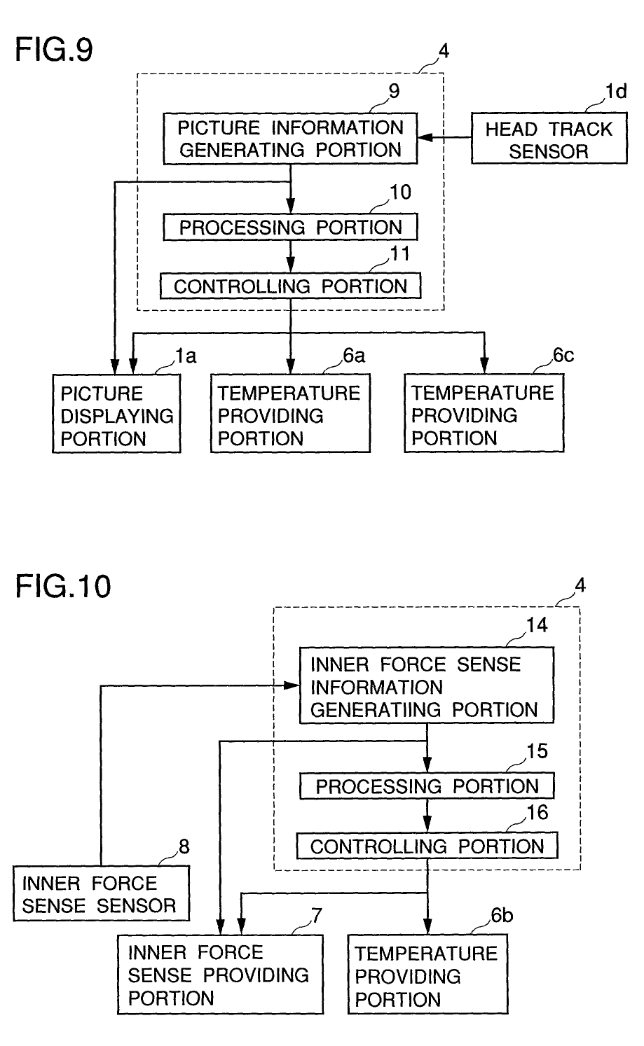

FIG. 9 is a block diagram showing the picture information generating portion 9 and the associated portions included in the VR space generating portion 4. In the picture information generating portion 9, for example, information on 3-D pictures such as 3-D computer graphics is generated and stored. To the 3-D picture information, the head position detection result from the head track sensor 1d is added, and the resultant picture information supplied to the picture displaying portion 1a is reproduced and transmitted to processing portion 10.

The processing portion 10 calculates the distribution of the picture plane brightness of the transmitted picture information and generates temperature provision data based on the distribution signal. For example, the generation of temperature provision data such that since the above-mentioned portion of the sun in the upper left of FIG. 8 is high in brightness, the temperature provided in the area “a” of the temperature providing portion 6cL is high is performed by the processing portion 10. Controlling portion 11 outputs a control signal based on the temperature provision data to the temperature providing portions 6c, and outputs a synchronizing signal so that the timing of output of the control signal coincides with the timing of transmission of the picture information to the picture displaying portion 1a.

The processing portion 10 not only obtains the picture plane brightness distribution based on the picture information as described above but also acquires information, for example, on the season of the picture projected on the display screen from the picture information. Then, based on the season information, for example, temperature provision data is generated such that when the season is summer, a warm temperature is provided overall. The controlling portion 11 of this embodiment controls the temperature providing portions 6a in the chair 5 based on the temperature provision data. That is, the chair 5 becomes warm when a picture of summer is projected, and becomes cold when a picture of winter is projected, whereby the viewer can experience a virtual reality space with higher presence.

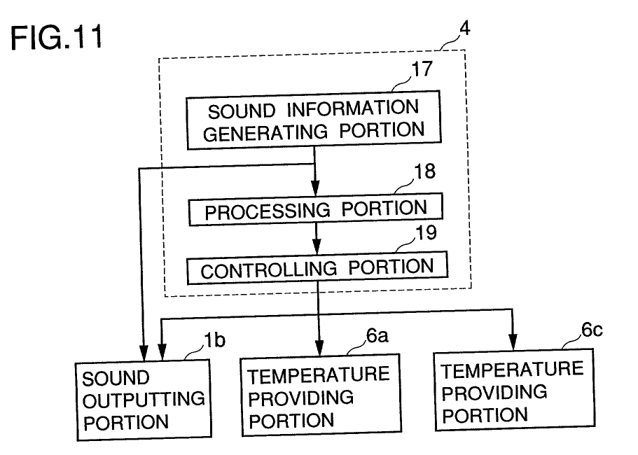

FIG. 10 is a block diagram showing the inner force sense information generating portion 14 and the associated portions included in the VR space generating portion 4. The inner force sense information generating portion 14 generates inner force sense information based on information from the inner force sense sensor 8. For example, when the viewer grabs an object in a VR space, the inner force sense sensor 8 detects this, and based on the detection result, the inner force sense information generating portion 14 generates inner force sense information representative of provision of a reactional force to a finger or a hand. The inner force sense information is transmitted to the inner force sense providing portion 7, so that the viewer is actually provided with a reactional force.

Processing portion 15 generates temperature provision data based on the inner force sense information. For example, when the object in the VR space grabbed by the viewer is determined to be hot based on the inner force sense information, temperature provision data representing provision of a high temperature is provided. Controlling portion 16 generates a control signal based on the temperature provision data and outputs it into the temperature providing portions 6b. The controlling portion 16 outputs a synchronizing signal so that the timing of transmission of the inner force sense information to the inner force sense providing portion 7 coincides with the timing of transmission of the control signal to the temperature providing portions 6b.

FIG. 11 is a block diagram showing the sound information generating portion 17 and the associated portions included in the VR space generating portion 4. The sound information generating portion 17 generates sound information. The sound information is supplied to the sound outputting portion 1b which outputs the sound information as sound.

Processing portion 18 generates temperature provision data based on the sound information. For example, when sad music or a sound producing a sense of terror is provided, temperature provision data representing provision of a sense of coldness is generated. When Latin music or cheerful rock music is provided, temperature provision data representing provision of a sense of warmth is generated. Controlling portion 19 generates a drive signal based on the temperature provision data and outputs it to the temperature providing portions 6a and 6d. The controlling portion 19 generates and outputs a synchronizing signal so that the temperature change of the temperature providing portions 6a and 6b corresponds to the sound information outputted to the sound outputting portion 1b.

It should be understood that the present invention is achieved even when the temperature providing portions controlled by the controlling portions shown in the block diagrams of FIGS. 9 to 11 are not as shown in the figures. For example, the control of the temperature providing portions based on the sound information may also be performed on the temperature providing portions 6c. Moreover it is not necessary that the temperature provision data is generated based on the picture information and the sound information. Here, the temperature provision data may also be generated without the information of the picture and the sound. Then the sense of temperature is provided for the viewer based on the temperature provision data.

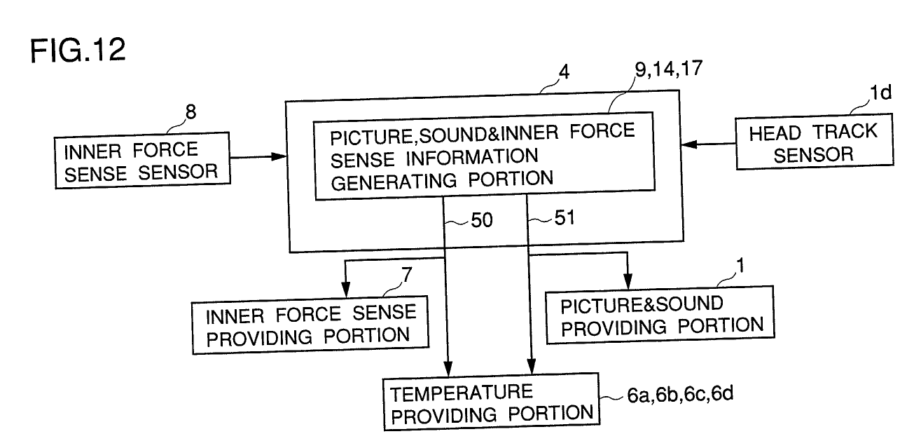

FIG. 12 briefly shows the means shown in FIGS. 9 to 11 together. That is, FIG. 12 is a block diagram showing a schematic structure of the display apparatus of this embodiment. In this apparatus, at the arrow 50, information from the inner force sense sensor 8 is added to the inner force sense information generated by the inner force sense information generating portion 14, and the resultant inner force sense information is supplied to the inner force sense providing portion 7. The temperature providing portions 6b are controlled based on the inner force sense information.

At the arrow 51, information from the head track sensor 1d is added to the picture information and the sound information generated by the picture generating portion 9 and the sound generating portion 17, and the resultant picture information and sound information are supplied to the picture and sound providing portion 1. The temperature providing portions 6a, 6c and 6d are controlled based on the picture information and the sound information. Thus, the VR space information generating portion 4 which also generates information on temperature serves also as temperature information generating means.

Second Embodiment

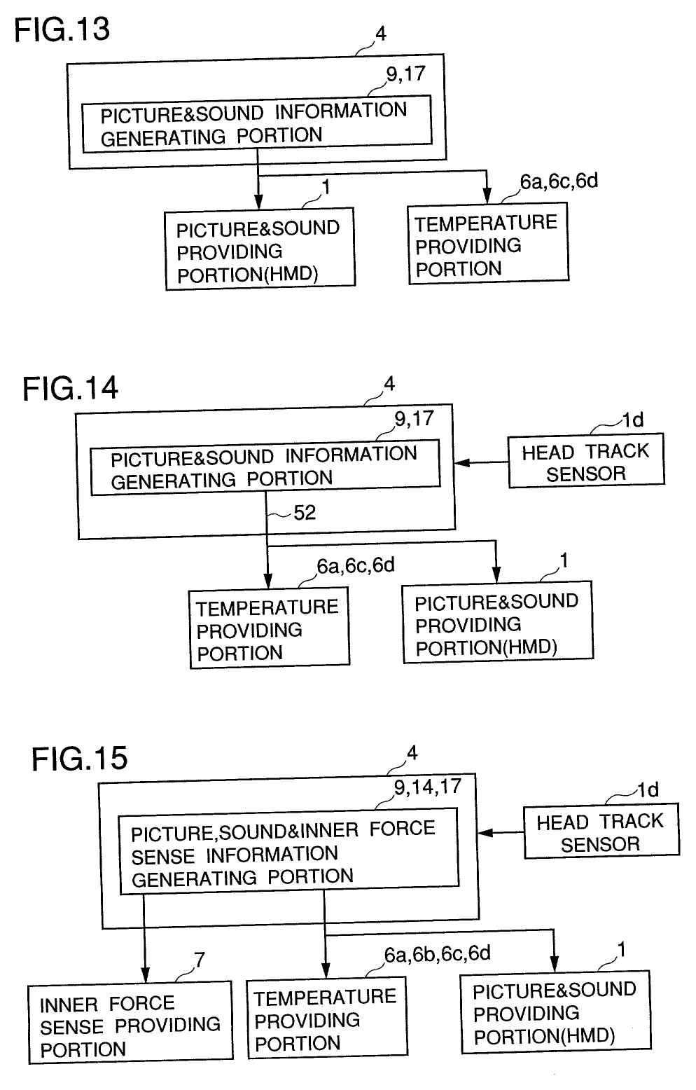

FIG. 13 is a block diagram showing a schematic structure of a display apparatus of a second embodiment. This apparatus is designed so that VR space information generated by the picture and the sound information generating portions 9 and 17 is outputted to the HMD 1. The temperature providing portions 6a, 6c and 6d are controlled based on the VR space information. This apparatus will not be described in detail because it is different from the apparatus of the first embodiment only in that the portions associated with the inner force sense providing portion 7 and the head track sensor 1d are not provided.

Third Embodiment

FIG. 14 is a block diagram showing a schematic structure of a display apparatus of a third embodiment. This apparatus has the same structure as the second embodiment except that the head track sensor 1d is provided. Information is generated by the picture and the sound information generating portions 9 and 17. At the arrow 52, information from the head track sensor 1d is added to the information outputted from the picture and the sound information generating portions 9 and 17, and the resultant information is supplied to the picture and sound providing portion 1. The temperature providing portions 6a, 6c and 6d are controlled based on VR space information. Other arrangements are the same as those of the second embodiment.

Fourth Embodiment

FIG. 15 is a block diagram showing a schematic structure of a display apparatus of a fourth embodiment. This apparatus comprises the picture, the sound and the inner force sense information generating portions 9, 14 and 17 and the inner force sense providing portion 7. Information generated by the information generating portion 9, 14 and 17 is also supplied to the inner force sense providing portion 7. Other arrangements are the same as those of the third embodiment.

Fifth Embodiment

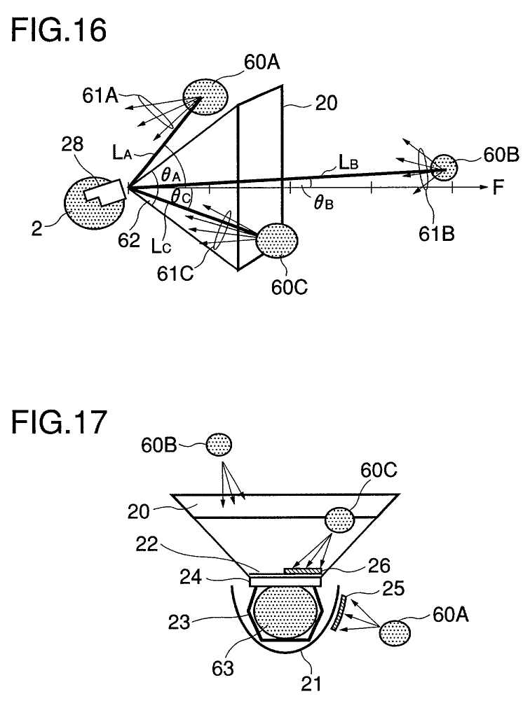

The principle of a display apparatus of this embodiment will be described with reference to FIG. 16. FIG. 16 shows the viewer 2 wearing the apparatus 28 of this embodiment and viewing a picture displayed on displaying portion. Reference numeral 20 represents the frame of the picture viewed by the viewer 2. Reference numeral 62 represents angle of view of the picture. The apparatus 28 is designed to provide the viewer 2 with a sense of temperature based on the radiant heats from virtual objects existing in a VR space (in a space not limited to the field of view).

VR space information prepared includes information on the colors, the brightnesses, the distances, the directions and the radiant heats of virtual objects existing 360 degrees around the viewer. Assuming that virtual objects 60A, 60B and 60C exist in the VR space, these objects are shown in FIG. 16.

The virtual object 60A exists at an angle θ_{A} from the direction of the viewer's head F and at a distance L_{A} in the VR space, and has a radiant heat 61A. For the other virtual objects 60B and 60C, information on the distance L_{B} and L_{C}, the direction θ_{B} and θ_{C} and the radiant heat 61B and 61C are also prepared. In 5the apparatus 28, the temperature that the viewer is provided with is controlled based on the information. Hereinafter, a temperature providing method of the apparatus 28 based on the radiant heats from virtual objects will be described.

FIG. 17 schematically shows the viewer wearing the apparatus of this embodiment and the virtual objects in the VR space viewed from above. In FIG. 17, it is assumed that the viewer is situated in the same position in the VR space as in FIG. 16. The apparatus is held on the viewer's head 63 by head holding portion 23, and is fixed so that picture displaying portion 24 of the apparatus is situated in front of the eyes. Reference numerals 21 and 22 represent temperature providing portions included in the apparatus.

Reference numeral 20 represents the frame of the picture viewed by the viewer 2. The area and intensity of temperature provision depend on conditions calculated based on the radiant heat and the distance. The amount of heat radiating from a heat source typically decreases inversely with the square of the distance from the heat source. Therefore, in this embodiment, the temperature to be provided is calculated based on data concerning the distance and the radiant heat from a virtual object. The temperature provision area is controlled in consideration of the direction in which the virtual object exists. In this case, whether the virtual object exists in the field of view or not is not taken into consideration.

By the above-described control, the sense of temperature based on the radiant heat 61A from the virtual object 60A is provided in an area 25 of the temperature providing portion 21. Likewise, the sense of temperature based on the radiant heat 61C from the virtual object 60C is provided in an area 26 of the temperature providing portion 22. For the virtual object 60B, temperature provision is not performed because the distance L_{B} therefrom is long and the radiant heat 61B therefrom is not high.

By such control, temperature provision based on the radiant heat from an object not existing in the viewer's field of view is also performed, so that natural temperature provision is performed in accordance with the distance from the object. When the head moves, the movement is detected by a non-illustrated heat track sensor and the temperature to be provided is detected with consideration also given to the detection result.

Preferably, when the distance from and the direction of a virtual object varies because the viewer 2 moves in a VR space, temperature provision data is calculated as occasion requires so that an optimum temperature is provided in an optimum temperature provision area. The above-described temperature provision is effective, particularly, for 3-D picture information and CG images having distance information.

While the temperature providing portions are included in the display apparatus in the above-described first to fifth embodiments, the temperature providing portions are not limited thereto. For example, an air conditioner may be used as the temperature providing portion (apparatus). In this case, temperature is provided in the entire space.

Obviously, many modifications and variations of the present invention are possible in light of the above teachings. It is therefore to be understood that within the scope of the appended claims, the invention may be practiced other than as specifically described.

What is claimed is:

1. A display apparatus comprising:
picture displaying means for providing a viewer with a picture; and
heat generating means for providing the viewer with heat.

2. A display apparatus as claimed in claim 1, wherein said heat generating means provides the viewer with a heat in accordance with the picture.

3. A display apparatus as claimed in claim 2, wherein said heat generating means provides the viewer with a heat in accordance with a brightness of the picture.

4. A display apparatus as claimed in claim 1, wherein said heat generating means changes, in accordance with the picture, a portion where the viewer is provided with heat.

5. A display apparatus as claimed in claim 1, wherein the picture that said picture displaying means provides the viewer with is a virtual picture.

6. A display apparatus as claimed in claim 5, further comprising:
a sensor for detecting a pressure;
means for detecting with said sensor that the viewer grabs an object within the virtual picture; and
means for providing the viewer with a heat in accordance with the object grabbed by the viewer.

7. A display apparatus comprising:
picture displaying means for providing a viewer with a picture;
sound outputting means for providing the viewer with sound; and
heat generating means for providing the viewer with heat.

8. A display apparatus as claimed in claim 7, wherein the picture that said picture displaying means provides the viewer with is a virtual picture.

9. A display apparatus as claimed in claim 7, wherein said heat generating means provides a heat in accordance with the picture.

10. A display apparatus as claimed in claim 9, wherein said heat generating means provides the viewer with a heat in accordance with a brightness of the picture.

11. A display apparatus as claimed in claim 7, wherein said heat generating means provides a heat in accordance with the sound.

12. A display apparatus comprising:
means for outputting a video signal;
means for displaying a picture based on the video signal; and
means for generating heat based on the video signal.

13. A display apparatus as claimed in claim 12, the picture that said picture displaying means provides the viewer with is a virtual picture.

14. A method of providing heat, comprising the steps of:
displaying an image; and
providing a viewer with a heat in accordance with the displayed image.

15. A method as claimed in claim 14, wherein said image is a virtual image.
